(19) United States
(12) Patent Application Publication
(10) Pub. No.: US 2007/0153035 A1
(43) Pub. Date: Jul. 5, 2007

(54) Inkjet image forming apparatus and control method of the same

(75) Inventors: Youn-gun Jung, Gunpo-si (KR); Heon-soo Park, Seongnam-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd, Suwon-si (KR)

(21) Appl. No.: 11/581,420

(22) Filed: Oct. 17, 2006

(30) Foreign Application Priority Data
Jan. 3, 2006 (KR) 2006-0509

(51) Int. Cl. B41J 29/38

(52) U.S. Cl. 347/9

(57) ABSTRACT

An inkjet image forming apparatus includes a printhead including a nozzle array having a plurality of nozzles arranged in a main scanning direction, an auxiliary printhead having an auxiliary nozzle to fire ink to assist the nozzles to print the image and capable of reciprocating in the main scanning direction, and a detecting unit formed integrally with the auxiliary printhead, and a control method of the inkjet image forming apparatus includes firing ink onto an ink firing position between ink dots printed by two neighboring nozzles in a high-resolution mode, and/or firing ink onto an ink firing position where a missing dot caused by a defective nozzle exists in a compensation mode.

### CROSS-REFERENCE TO RELATED APPLICATIONS

This application claims priority under 35 U.S.C. §119(a) from Korean Patent Application No. 10-2006-0000509, filed on Jan. 3, 2006, in the Korean Intellectual Property Office, the disclosure of which is incorporated herein in its entirety by reference.

### BACKGROUND OF THE INVENTION

1. Field of the Invention

The present general inventive concept relates to an inkjet image forming apparatus and a control method of the inkjet image forming apparatus, and more particularly, to an array type inkjet image forming apparatus having a plurality of nozzles arranged over a width direction of a printing medium for high-speed printing.

2. Description of the Related Art

Generally, an inkjet image forming apparatus prints an image on a printing medium by firing ink using an ink cartridge that is located a predetermined distance from a top surface of the printing medium and reciprocating in a perpendicular direction (hereinafter, referred to as a main scanning direction) to a feeding direction of the printing medium. The feeding direction of the printing medium is referred to as a subsidiary scanning direction, and the subsidiary scanning direction is perpendicular to the main scanning direction. The ink cartridge, which fires ink onto the printing medium while reciprocating in the main scanning direction as described above, is referred to as a shuttle type ink cartridge.

On the contrary, an array type ink cartridge does not reciprocate. The array type ink cartridge is fixed to a predetermined position while the printing medium is fed in the subsidiary scanning direction. An image forming apparatus employing the array type ink cartridge has a simple structure and a high print speed. However, since the array type ink cartridge cannot move in the main scanning direction, the print quality of the array type ink cartridge is negatively affected by defective nozzles, and it is difficult to compensate for the defective nozzles. Further, since it is difficult to structurally increase a nozzle density of the array type ink cartridge in the main scanning direction, a print resolution of the array type ink cartridge is relatively low.

The array type ink cartridge includes a nozzle array having a plurality of nozzles arranged over a width direction of a printing medium for firing ink. Therefore, if some of the nozzles are defective due to electrical or mechanical damage, the ink is not normally fired. Examples of defective nozzles include a missing nozzle and a weak nozzle. When the array type ink cartridge prints an image on the printing medium, the defective nozzles cause white lines on the printed image along the feeding direction of the printing medium, thereby decreasing a print quality of the printed image.

In one approach dealing with the defective nozzles in an array type ink cartridge, nozzles adjacent to the defective nozzles are controlled to fire ink droplets larger than normal ink droplets to compensate for the defective nozzles. However, the print quality degradation cannot be sufficiently prevented with this method since the ink droplets are not fired exactly onto the white lines. On the contrary, in the shuttle type ink cartridge, defective nozzles can be easily compensated for by firing ink exactly onto the white lines from other normal nozzles while moving the shuttle type ink cartridge in the main scanning direction. Therefore, in order to compensate for defective nozzles of the array type ink cartridge, the ink firing positions of the nozzles onto the printing medium along the main scanning direction should be varied in order to fire the ink exactly onto the white lines.

Meanwhile, a print resolution of the array type ink cartridge is determined by a number of nozzles per unit length. However, it requires a high cost and causes many manufacturing problems to structurally increase a nozzle density of the array type ink cartridge. On the contrary, although the shuttle type ink cartridge has the same problems for increasing its nozzle density, the shuttle type ink cartridge can move to change the ink firing positions of the nozzles in the main scanning direction. Therefore, the print quality of the shuttle type ink cartridge can be increased by controlling the ink firing positions of the nozzles without structurally increasing the nozzle density. Thus, the ink firing positions of the nozzles in the main scanning direction should be varied to increase the density of fired ink and thereby increase the print resolution of the array type ink cartridge.

### SUMMARY OF THE INVENTION

The present general inventive concept provides an inkjet image forming apparatus that has a defective nozzle compensation unit and a print resolution enhancing unit useable in an array type ink cartridge, and a method of controlling the inkjet image forming apparatus.

Additional aspects and advantages of the present general inventive concept will be set forth in part in the description which follows and, in part, will be obvious from the description, or may be learned by practice of the general inventive concept.

The foregoing and/or other aspects and utilities of the present general inventive concept may be achieved by providing an inkjet image forming apparatus, including a printhead including a nozzle array having a plurality of nozzles arranged in a main scanning direction to print an image by firing ink onto a printing medium, an auxiliary printhead spaced apart from the printhead in an advancing direction of the printing medium and capable of reciprocating in the main scanning direction, the auxiliary printhead including an auxiliary nozzle to fire ink to assist the nozzles to print the image, and a detecting unit formed integrally with the auxiliary printhead to scan the printing medium to detect the printed image using the nozzles and the auxiliary nozzle.

The inkjet image forming apparatus may further include a control portion to control the nozzles, the auxiliary nozzle, and the detecting unit to perform at least one of a high-density print mode and a compensation mode, the control portion may perform the high-density print mode by determining an ink firing position between ink dots printed by two neighboring nozzles of the nozzles in the main scanning direction and by controlling the auxiliary nozzle to fire additional ink onto the determined ink firing position, and the control portion may perform the compensation mode by determining a missing dot caused by a defective nozzle of the nozzles as an ink firing position and by controlling the auxiliary nozzle to fire ink onto the ink firing position of the defective nozzle.

The inkjet image forming apparatus may further include a carrying unit to feed the printing medium in a subsidiary scanning direction, and the control portion may synchronize the ink firing positions of the nozzles and the auxiliary nozzle on the printing medium in the subsidiary scanning direction by monitoring the carrying unit to detect a feeding amount of the printing medium.

The inkjet image forming apparatus may further include a reciprocating unit to move the auxiliary printhead back and forth in the main scanning direction, and the control portion may synchronize the ink firing positions of the nozzles and the auxiliary nozzle on the printing medium in the main scanning direction by monitoring the reciprocating unit to detect a moving amount of the auxiliary printhead.

The control portion may determine the ink firing position of the auxiliary nozzle by controlling the nozzles to fire the ink to print a nozzle test pattern on the printing medium and controlling the detecting unit to scan the nozzle test pattern.

The control portion may correct the determined ink firing position of the auxiliary nozzle by controlling the auxiliary nozzle to print an auxiliary nozzle test pattern onto the determined ink firing position and by controlling the detecting unit to scan the auxiliary nozzle test pattern.

The control portion may control the nozzles, the auxiliary nozzle, and the detecting unit to scan the nozzle test pattern, to print the auxiliary nozzle test pattern, and to scan the auxiliary nozzle test pattern while the auxiliary printhead reciprocates in a same swath.

The control portion may control the detecting unit to scan the nozzle test pattern while moving the auxiliary printhead one way in the main scanning direction, control the auxiliary nozzle to print the auxiliary nozzle test pattern while moving the auxiliary printhead the other way in the main scanning direction, and control the detecting unit to scan the auxiliary nozzle test pattern while moving the auxiliary printhead the one way in the main scanning direction again.

The nozzle test pattern may include a plurality of lines extended in a subsidiary scanning direction and arranged along the main scanning direction in parallel with one another.

The nozzles may be divided into a plurality of groups, and the nozzle test pattern may be printed by the ink fired from nozzles selected from the respective groups.

The lines of the nozzle test pattern may be spaced a predetermined distance from one another, and the predetermined distance may be larger than a resolution of the detecting unit.

The detecting unit may include an optical sensor to detect the nozzle test pattern by projecting light to the printing medium and by comparing an optical output signal obtained from the light reflected from the printing medium with a threshold value.

The auxiliary nozzle and an optical focus of the optical sensor may be placed within a same swath.

The inkjet image forming apparatus may further include a maintenance portion to control the detecting unit to detect the defective nozzle and to control the maintenance portion to perform wiping and spitting operations on the defective nozzle before controlling the auxiliary nozzle to fire the ink onto the ink firing position corresponding to the defective nozzle.

The foregoing and/or other aspects and utilities of the present general inventive concept may also be achieved by providing a method of controlling an inkjet image forming apparatus that includes a printhead having a nozzle array having a plurality of nozzles arranged in a main scanning direction to print an image by firing ink onto a printing medium, an auxiliary printhead spaced apart from the printhead in an advancing direction of the printing medium and capable of reciprocating in the main scanning direction, the auxiliary printhead including an auxiliary nozzle to fire ink to assist the nozzles to print the image, and a detecting unit formed integrally with the auxiliary printhead to scan the printing medium to detect the printed image using the nozzles and the auxiliary nozzle, the method including selecting at least one of a high-resolution mode and a compensation mode, when the high-resolution mode is selected, determining an ink firing position between ink dots printed by two neighboring nozzles of the nozzles in the main scanning direction and firing additional ink onto the determined ink firing position using the auxiliary nozzle, and when the compensation mode is selected, determining a missing dot caused by a defective nozzle of the nozzles as an ink firing position for the auxiliary nozzle and firing ink onto the ink firing position of the defective nozzle using the auxiliary nozzle.

The selecting of the at least one of the high-resolution mode and the compensation mode may include selecting the high-resolution mode, printing a nozzle test pattern on the printing medium by firing the ink using the nozzles, feeding the printing medium to the auxiliary printhead, scanning the nozzle test pattern using the detecting unit, determining the ink firing position of the auxiliary nozzle on the printing medium between the ink dots printed by the two neighboring nozzles by referring to the scanned nozzle test pattern, printing an auxiliary nozzle test pattern by firing the ink onto the determined ink firing position using the auxiliary nozzle, scanning the auxiliary nozzle test pattern using the detecting unit to determine whether the ink firing positions of the nozzles and the auxiliary nozzle on the printing medium are synchronized, and when the ink firing positions of the nozzles and the auxiliary nozzle on the printing medium are synchronized, printing desired image data in the high-resolution mode.

The selecting of the at least one of the high-resolution mode and the compensation mode may include selecting the compensation mode, printing a nozzle test pattern on the printing medium by firing the ink using the nozzles, feeding the printing medium to the auxiliary printhead, scanning the nozzle test pattern using the detecting unit, locating the missing dot caused by the defective nozzle referring to the scanned nozzle test pattern and determining the missing dot as the ink firing position for the auxiliary nozzle, printing an auxiliary nozzle test pattern by firing ink onto the determined ink firing position using the auxiliary nozzle, scanning the auxiliary nozzle test pattern using the detecting unit to determine whether the ink firing positions of the nozzles and the auxiliary nozzle on the printing medium are synchronized, and when the ink firing positions of the nozzles and the auxiliary nozzle on the printing medium are synchronized, printing desired image data in the compensation mode.

The foregoing and/or other aspects and utilities of the present general inventive concept may also be achieved by providing a printhead unit of an image forming apparatus, the printhead unit including a first printhead comprising a plurality of first nozzles to eject ink onto a printing medium to form an image on the printing medium, and a second printhead spaced apart from the first printhead by a predetermined distance in a conveying direction of the printing medium and moveable in a main scanning direction perpendicular to the conveying direction, the second printhead comprising a plurality of second nozzles to eject ink onto the printing medium to increase a print resolution of the printhead unit and/or to compensate for a defective nozzle of the plurality of first nozzles.

The first printhead may be an array type printhead and the second printhead may be a shuttle type printhead. The printhead unit may further include a detecting unit attached to the second printhead to detect the image printed on the printing medium, and a control unit to control operations of the first printhead, the second printhead, and the detecting unit. The detecting unit and the plurality of second nozzles may be spaced apart from each other by a first predetermined distance in the main scanning direction. The detecting unit and the plurality of first nozzles may be spaced apart from each other by a second predetermined distance in the conveying direction, and the detecting unit may be spaced apart from a nozzle of the plurality of first nozzles by a third predetermined distance in the main scanning direction.

The control unit may store constant values corresponding to the first, second, and third predetermined distances. The control unit may synchronize the ejection of the ink by the plurality of first nozzles and the plurality of second nozzles using the constant values. The control unit may continuously update the constant values to precisely align ink dots ejected by the first and second printheads onto the printing medium. The control unit may update the constant values during predetermined time periods to precisely align ink dots ejected by the first and second printheads onto the printing medium. The first printhead may eject a plurality of ink drops at locations on the printing medium corresponding to the plurality of first nozzles, and the second printhead may eject at least one auxiliary ink drop between two adjacent ink drops of the plurality of ink drops to increase the print resolution of the printhead unit. The plurality of first nozzles may include the defective nozzle, and the second printhead may eject at least one ink drop at a location on the printing medium corresponding to the defective nozzle to compensate for the defective nozzle.

The foregoing and/or other aspects and utilities of the present general inventive concept may also be achieved by providing an inkjet image forming method, including ejecting ink dots onto a printing medium using a plurality of first nozzles of a first printhead as the printing medium moves in a conveying direction to form a first print line of an image, stopping the movement of the printing medium and ejecting auxiliary ink dots onto predetermined positions on the first print line using a plurality of second nozzles of a second printhead spaced apart from the first printhead by a predetermined distance in the conveying direction, the second printhead being moveable in a main scanning direction perpendicular to the conveying direction, and moving the printing medium having the ejected ink dots and auxiliary ink dots in the conveying direction and repeating the ejecting of the ink dots using the plurality of first nozzles, the stopping of the movement of the printing medium, and the ejecting of the auxiliary ink dots using the plurality of second nozzles for each print line of the image.

The predetermined positions on the first print line may correspond to at least one of locations between adjacent one of the ink dots ejected by the plurality of first nozzles, and locations of blank dots of at least one defective nozzle of the plurality of first nozzles. The predetermined positions on the first print line may correspond to locations between adjacent one of the ink dots ejected by the plurality of first nozzles, and locations of blank dots of at least one defective nozzle of the plurality of first nozzles.

The foregoing and/or other aspects and utilities of the present general inventive concept may also be achieved by providing an image forming apparatus, including a first printhead having a plurality of first nozzles to form an image on a printing medium, a second printhead having a plurality of second nozzles, and a control unit to control the second printhead to form a second image on the printing medium with the image according to one of a high definition mode and a compensation mode.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a side sectional view illustrating an inkjet image forming apparatus, according to an embodiment of the present general inventive concept;

FIG. 2 is a perspective view illustrating a reciprocating unit and a carrying unit of FIG. 1, according to an embodiment of the present general inventive concept;

FIG. 3 is a perspective view illustrating a printhead of the inkjet image forming apparatus of FIG. 1, according to an embodiment of the present general inventive concept;

FIG. 4 is a view illustrating an operation of a control portion of the inkjet image forming apparatus of FIG. 1, according to an embodiment of the present general inventive concept;

FIG. 5A is a view illustrating a nozzle test pattern, according to an embodiment of an embodiment of the present general inventive concept;

FIG. 5B is a view illustrating an auxiliary nozzle test pattern printed in a high-density print mode with respect to the nozzle test pattern illustrated in FIG. 5A, according to an embodiment of an embodiment of the present general inventive concept;

FIG. 6A is a view illustrating a nozzle test pattern when defective nozzles exist, according to an embodiment of the present general inventive concept;

FIG. 6B is a view illustrating an auxiliary nozzle test pattern printed in a compensation mode with respect to the nozzle test pattern illustrated in FIG. 6A, according to an embodiment of an embodiment of the present general inventive concept;

FIG. 7A is a view illustrating a nozzle test pattern when defective nozzles exist, according to an embodiment of the present general inventive concept;

FIG. 7B is a view illustrating an auxiliary nozzle test pattern printed in high-density print and compensation modes with respect to the nozzle test pattern illustrated in FIG. 7A, according to an embodiment of an embodiment of the present general inventive concept;

FIG. 8A is a view illustrating a nozzle test pattern printed using grouped nozzles, according to an embodiment of the present general inventive concept;

FIG. 8B is a view illustrating an auxiliary nozzle test pattern printed in high-density print and compensation modes with respect to the nozzle test pattern illustrated in FIG. 8A, according to an embodiment of an embodiment of the present general inventive concept; and

FIGS. 9A and 9B are flowcharts illustrating a control method of an inkjet image forming apparatus, according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

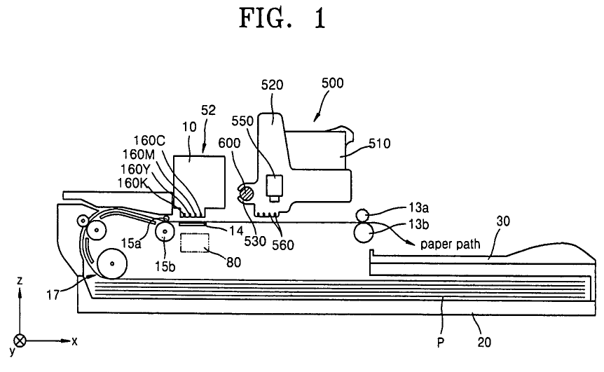

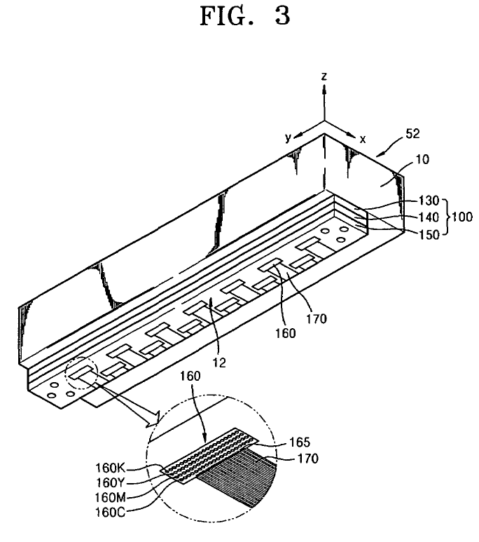

FIG. 1 is a side sectional view illustrating an inkjet image forming apparatus, according to an embodiment of the present general inventive concept. Referring to FIG. 1, the inkjet image forming apparatus includes an array type printhead 52, a cassette 20 to store printing media (P), a pick-up roller 17 to pick up the printing media (P) one by one, feed rollers 15a and 15b to feed the picked-up printing medium (P) to a nozzle unit 12 (see to FIG. 3), a platen 14 to guide the printing medium (P) fed by the feeding rollers 15a and 15b while keeping the printing medium (P) at a predetermined distance from the nozzle unit 12, a maintenance portion 80 facing the printhead 52 with the printing medium (P) to pass between the maintenance portion 80 and the printhead 52, output rollers 13a and 13b to discharge the printing medium (P) after an image is printed on the printing medium (P), an output tray 30 to receive the printing medium (P) from the output rollers 13a and 13b, and an auxiliary shuttle type printhead 500.

The printing medium (P) is fed in an x-axis direction (a length direction of the printing medium (P) referred to as a subsidiary scanning direction x), and a width direction of the printing medium (P) is denoted by a y-axis (referred to as a main scanning direction y).

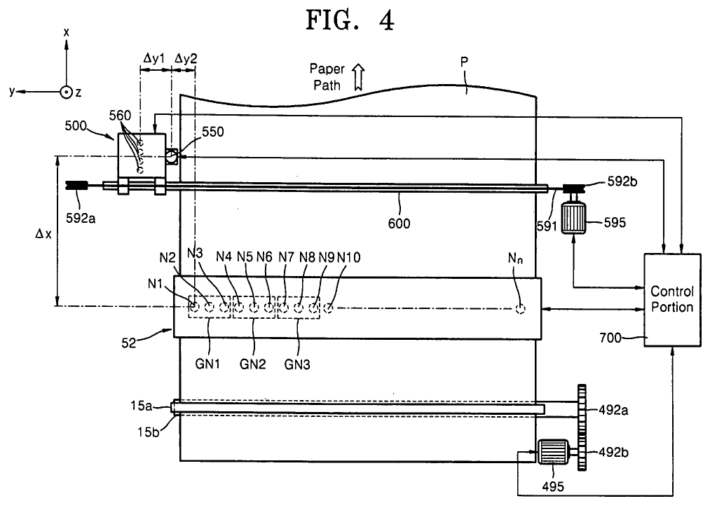

The array type printhead 52 includes a body 10, an ink tank (not illustrated) formed in the body 10 to contain ink according to colors of the ink, and the nozzle unit 12 (see FIG. 3) to fire ink onto the printing medium (P). In an inkjet image forming apparatus capable of printing a color image, the nozzle unit 12 includes four nozzle arrays, such as cyan, magenta, yellow, and black nozzle arrays 160C, 160M, 160Y, and 160K. Each of the nozzle arrays 160C, 160M, 160Y, and 160K may include a plurality of nozzles N1, N2, N3, . . . Nn (see FIG. 4) arranged parallel to or at an angle to the main scanning direction y to fire the ink onto the printing medium (P). Printing data corresponding to a line of the image to be printed may be printed on the printing medium (P) at one time in the main scanning direction y using the plurality of nozzles N1, N2, N3, . . . Nn.

The output roller 13a may be a star wheel, and the output roller 13b may be a supporting roller to support a bottom surface of the printing medium (P). The star wheel 13a makes point-contact with a top surface of the printing medium (P), such that damage to the ink image formed on the top surface of the printing medium (P) before the ink image is completely dried can be prevented.

The maintenance portion 80 may perform a capping operation to cap the nozzle unit 12 to prevent the ink from drying, a wiping operation to wipe the nozzle unit 12 to remove ink remaining on the nozzle unit 12, and/or a spitting operation to prevent the nozzle unit 12 from clogging. When a detecting unit 550 detects a defective nozzle, the maintenance portion 80 may perform wiping and spitting operations on the defective nozzle before the ink is fired from the defective nozzle.

The auxiliary shuttle type printhead 500 contains ink of different colors when printing the color image. The auxiliary printhead 500 includes an ink cartridge 510 detachably mounted on a carriage 520, auxiliary nozzles 560 to receive ink from the ink cartridge 510 and to fire the ink onto the printing medium (P), the carriage to reciprocate in the main scanning direction y and the detecting unit 550 integrally assembled to the carriage 520 to detect the image, and a guide portion 530 receiving a guide shaft 600. The auxiliary shuttle type printhead 500 is a shuttle type printhead that reciprocates in the main scanning direction y. The auxiliary shuttle type printhead 500 fires ink to supplement an operation of the nozzle arrays 160C, 160M, 160Y, and 160K of the array type printhead 52 to compensate for one or more defective nozzles of the array type printhead 52 and so that high-density printing can be performed.

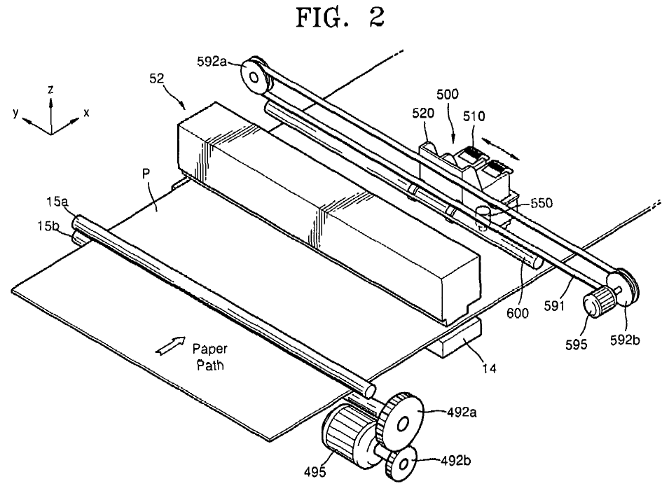

FIG. 2 is a perspective view illustrating a reciprocating unit and a carrying unit of FIG. 1, according to an embodiment of the present general inventive concept. The reciprocating unit includes a timing belt 591 having a portion fixed to the auxiliary printhead 500 and a toothed inner surface, pulleys 592a and 592b supporting both ends of the timing belt 591, a driving unit 595 to drive the pulleys 592a and 592b, the guide shaft 600 to guide the carriage 520, and the guide portion 530 (see FIG. 1) in which the guide shaft 600 is movably inserted. The reciprocating unit moves the auxiliary printhead 500 back and forth in the main scanning direction y. The carrying unit includes a driving unit 495, feed rollers 15a and 15b, and gears 492a and 492b to connect the driving unit 495 and the feed roller 15b to transmit power from a power source (not illustrated) to the carrying unit. The carrying unit feeds the printing medium (P) in the subsidiary scanning direction x.

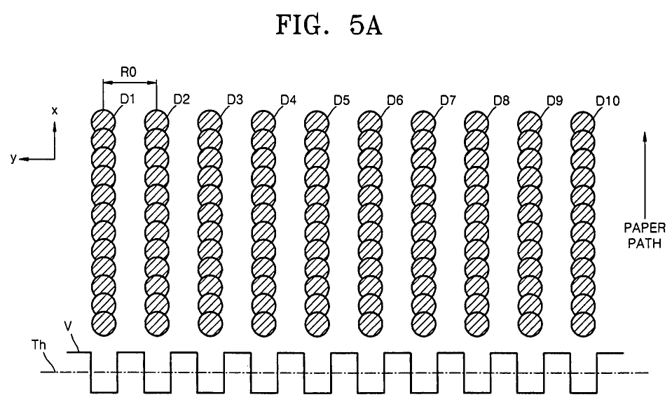

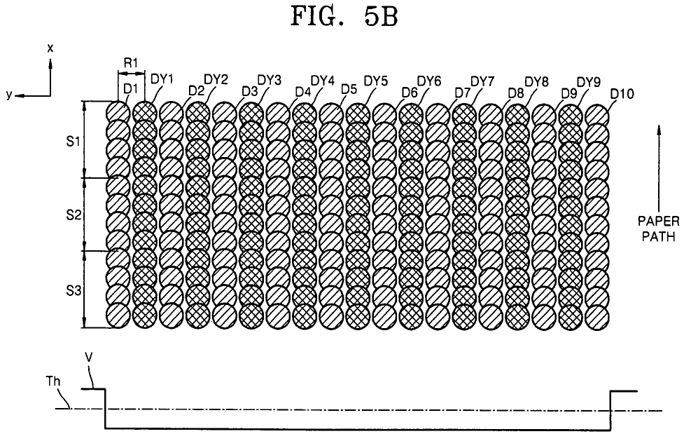

FIG. 3 is a perspective view illustrating the array type printhead 52 of the inkjet image forming apparatus of FIG. 1, according to an embodiment of the present general inventive concept. Referring to FIG. 3, the printhead 52 includes the nozzle unit 12 and an ink channel unit 100. The nozzle unit 12 has a length corresponding to the width of the printing medium (P) along the main scanning direction y, such that a printing data line can be printed at one time in the main scanning direction y. The nozzle unit 12 includes a plurality of head chips 160. Each of the head chips 160 includes the four nozzle arrays 160C, 160M, 160Y, and 160K to fire cyan (C), magenta (M), yellow (Y), and black (K) ink to form a color image. Inks of different colors are supplied to the nozzle arrays 160C, 160M, 160Y, and 160K from a back of the head chip 160. The head chip 160 may include a heating unit (not illustrated) to generate bubbles by heating the ink, such that the ink can be fired as the bubbles expand. The head chip 160 may be connected to a control portion 700 (see FIG. 4) by a flexible printed circuit (FPC) 170 to receive a driving signal and driving power for firing the ink. The FPC 170 is soldered to an FPC terminal 165 of the head chip 160. Although the head chips 160 are staggered, the control portion 700 controls an operation of the head chips 160 in consideration of an x-axis deviation of the head chips 160 and a feeding amount of the printing medium (P) such that the ink fired onto the printing medium (P) from the nozzle arrays 160C, 160M, 160Y, and 160K of the head chips 160 can be synchronized in a line without the deviation in the x-axis direction. For example, although the black nozzle arrays 160K formed in the respective head chips 160 are not arranged on the same line along the y-axis direction, ink dots (see, for example, ink dots of dot lines D1 to D10 illustrated in FIG. 5A) can be printed on the printing medium (P) on the same line in parallel with the y-axis by synchronizing an ink firing time of the black nozzle arrays 160K based on the x-axis deviation of the head chips 160 and the feeding amount of the printing medium (P).

If the array type printhead 52 is capable of printing a color image, the array type printhead 52 includes a plurality of ink tanks (not illustrated) in the body 10 to store a plurality of colored inks, such as cyan (C), magenta (M), yellow (Y), and black (K) inks. The ink channel unit 100 forms an ink passage from the ink tanks (not illustrated) to the back of the head chips 160. The ink channel unit 100 may include a first channel plate 130, a second channel plate 140, and a third channel plate 150 that are formed by, for example, injection-molding a liquid crystal polymer (LCP).

FIG. 4 is a view illustrating an operation of the control portion 700 of the inkjet image forming apparatus of FIG. 1, according to an embodiment of the present general inventive concept. Referring to FIG. 4, the array type printhead 52, the shuttle type auxiliary printhead 500, the detecting unit 550, and the control portion 700 are illustrated.

Only black-and-white printing will now be described for conciseness. That is, among the nozzle arrays 160C, 160M, 160Y, and 160K, only the black nozzle arrays 160K will now be described. However, the description of printing using the black nozzle array 160K also applies to printing using color nozzle arrays, such as the cyan, magenta, and yellow color arrays 160C, 160M, and 160Y. The nozzles N1 though Nn illustrated in FIG. 4 are nozzles of the black nozzle arrays 160K. Except that color printing is performed by firing different color ink onto the same point of the printing medium (P) through the nozzle arrays 106C, 160M, 160Y, and 160K to form a colored dot, the black-and-white printing with the black nozzle arrays 160K is the same as the color printing with the color nozzle arrays, such as the cyan, magenta, and yellow color arrays 160C, 160M, and 160Y Further, in the case where the head chips 160 having the nozzle arrays 160C, 160M, 160Y, and 160K are staggered as illustrated in FIG. 3, an ink firing time of the head chips 160 having an X-axis deviation can be synchronized as described above, such that a virtually equivalent nozzle arrangement having nozzles arranged linearly and in parallel with the y-axis can be obtained like the nozzles N1 through Nn illustrated in FIG. 4. Although the number of nozzles N1 through Nn illustrated in FIG. 4 is n, ten nozzles N1 through N10 will now be described for conciseness.

The auxiliary printhead 500 is spaced apart from the array type printhead 52 in an advancing direction (a positive direction of the x-axis) of the printing medium (P) and detects the image printed on the printing medium (P) using the detecting unit 550 when the printing medium (P) is fed from the nozzle unit 12 to the auxiliary printhead 500. The auxiliary printhead 500 reciprocates in the main scanning direction y and includes the auxiliary nozzles 560 to fire the ink to assist the nozzles N of the array type printhead 52 to print the image on the printing medium. A swath (see, for example, swaths S1 to S3 illustrated in FIG. 5B) is defined as an areas on the printing medium (P) traced by the auxiliary shuttle type printhead 500 during a single reciprocating motion of the auxiliary shuttle type printhead 500 in the main scanning direction y when the printing medium (P) is stationary.

In a high-density print mode and a compensation mode, the feeding of a printing medium (P) is temporarily suspended and the auxiliary shuttle type printhead 500 reciprocates in the main scanning direction y to print the swath on the printing medium (P), and then the printing medium (P) is fed again to print a next swath. The auxiliary nozzles 560 may be arranged in the subsidiary scanning direction x, and a number of auxiliary nozzles 560 may be at least one in the subsidiary scanning direction x. In the case where the number of the auxiliary nozzles 560 is two or more in the subsidiary scanning direction x, a plurality of dot lines (see, for example, dot lines D1 to D10 illustrated in FIG. 5A) corresponding to the number of the auxiliary nozzles 560 can be printed in one swath.

The detecting unit 550 is formed integrally with the auxiliary shuttle type printhead 500. The detecting unit 550 reciprocates in the main scanning direction y and scans the printing medium (P) to detect the image printed on the printing medium (P) by the nozzles N1 to N10 and the auxiliary nozzles 560. The detecting unit 550 may be, for example, a camera sensor using a charge-coupled device (CCD) or a complementary metal oxide semiconductor (CMOS), or an optical sensor with a light emitting unit and a light receiving unit.

The control portion 700 is connected with the nozzles N1 to N10, the auxiliary nozzles 560, and the detecting unit 550 to control operations of these connected elements. The reciprocating unit and the carrying unit are also connected to the control portion 700. The control portion 700 monitors operations of the reciprocating unit and the carrying unit and detects displacements of the auxiliary shuttle type printhead 500 and the printing medium (P). The driving units 495 and 595 of the reciprocating unit and the carrying unit, respectively, may be, for example, step motors. In this case, the control portion 700 may detect the displacements of the auxiliary shuttle type printhead 500 and the printing medium (P) based on a frequency and number of pulses supplied to the step motors to drive the step motors. Alternatively, the reciprocating unit and the carrying unit may include encoders. In this case, the control portion 700 can detect the displacements of the reciprocating unit and the carrying unit by reading outputs of the encoders. It will be apparent to those of skill in the related art that various other devices can be used to monitor the operations of the reciprocating unit and the carrying unit. Thus, further descriptions thereof will be omitted.

As illustrated in FIG. 4, x-axis coordinates of the detecting unit 550 and a center of the auxiliary nozzles 560 are the same, and y-axis coordinates of the detecting unit 550 and the nozzles 560 are different by Δy1. Further, an x-axis distance between the nozzles N1 to N10 and the detecting unit 550 (or the center of the auxiliary nozzles 560) is Δx, and a y-axis distance between the first nozzle N1 and the detecting unit 550 is Δy1. The x-axis distance Δx and the y-axis distance Δy1 may be invariable. Furthermore, the detecting unit 550 and the auxiliary nozzles 560 are disposed at predetermined positions in a stand-by mode. That is, x and y coordinates of the nozzles N1 through Nn, a gap between the auxiliary nozzles 560, a position of the detecting unit 550 in the stand-by mode, Δy1, Δy2, and Δx may be constant values stored in the control portion 700.

In the present embodiment, when the printing medium (P) is fed by Δx in the x-axis direction after the ink is ejected from, for example, the nozzles N1 to N10, the control portion 700 determines that the ink firing position of the nozzles N1 to N10 is synchronized with the ink firing position of the auxiliary nozzle 560. Then, the control portion 700 stops the feeding of the printing medium (P) and moves the auxiliary shuttle type printhead 500 to print in one swath and scan the printed dot line in the one swath. In the case where the ink firing times of the nozzles N1 to N10 and the auxiliary nozzle 560 are determined as described above, the dots (such as the dots of the dot lines D1-D10 illustrated in FIG. 5A) printed on the printing medium (P) are arranged in the same dot line in parallel with the y-axis.

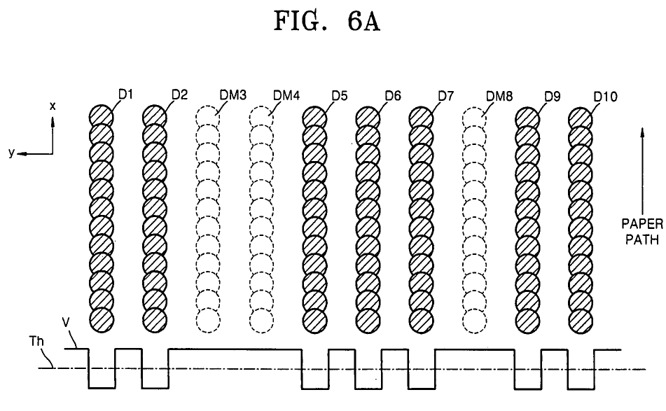

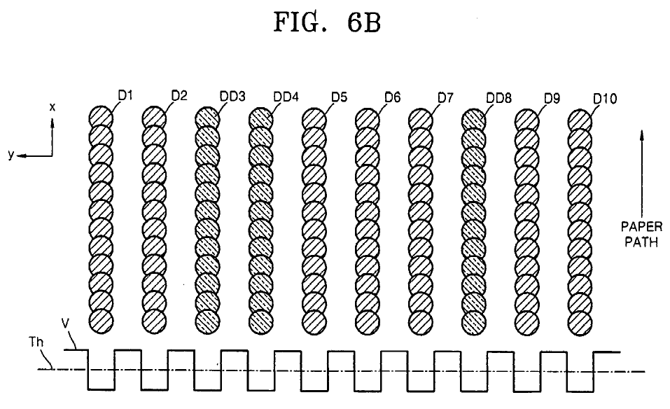

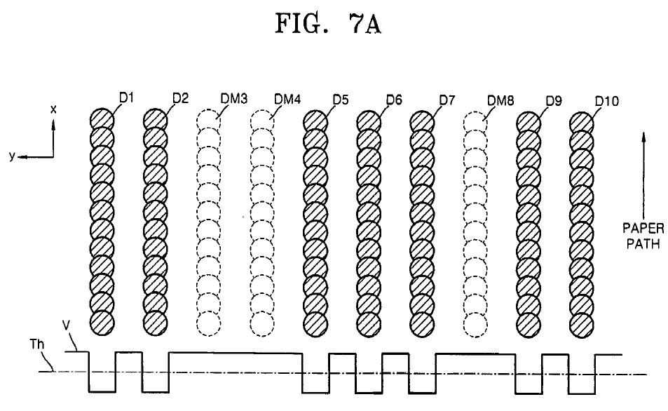

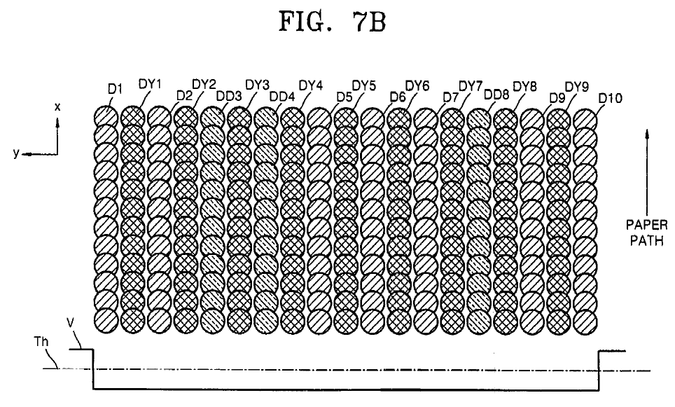

In another embodiment of the present general inventive concept, the control portion 700 synchronizes the ink firing positions of the nozzles N1 to N10 and the auxiliary nozzles 560 in the y-axis direction, based on the constant values, such as the x and y coordinates of the nozzles N1 through Nn, Δy1, and Δy2, and the displacement of the auxiliary printhead 500. By synchronizing the ink firing positions of the nozzles N1 to N10 and the auxiliary nozzles 560, the control portion 700 can also adjust the y-axis distance between the dots of dot lines D1 to D10 (see FIG. 5A) printed by the nozzles N1 to N10 and dots of dot lines DY1 to DY9 (see FIG. 5B and 7B) or DD3, DD4, and DD8 (see FIGS. 6B and 7B) printed by the auxiliary nozzles 560. Here, the dots of dot lines DY1 to DY9 (see FIGS. 5B and 7B) are dots printed by the auxiliary nozzles 560 in the high-resolution mode, and the dots of dot lines DD3, DD4, and DD8 (see FIGS. 6B and 7B) are dots printed by the auxiliary nozzles 560 in the compensation mode.

The control portion 700 performs at least one of the high-resolution mode and the compensation mode. In the high-resolution mode, the control portion 700 determines an ink firing position of the auxiliary nozzle 560 between two neighboring nozzles of the nozzles N1 to N10 and controls the auxiliary nozzle 560 to additionally fire ink onto the determined ink firing position, such that an additional ink dot formed by the auxiliary nozzle 560 can be positioned between two ink dots printed by the two neighboring nozzles of the nozzles N1 to N10. In the compensation mode, the control portion 700 determines an ink firing position of the auxiliary nozzle 560 in correspondence with a defective nozzle of the nozzles N1 to N10 and controls the auxiliary nozzle 560 to fire ink onto the determined ink firing position of the defective nozzle, such that the auxiliary nozzle 560 can form a compensation ink dot to compensate for an ink dot that should have been formed, but was not formed, by the defective nozzle.

In the high-resolution mode, the control portion 700 may move the auxiliary nozzle 560 to the ink firing position determined between ink dots printed by the two neighboring nozzles N1 to N10 and may control the auxiliary nozzle 560 to additionally fire ink on the determined ink firing position. Then, the control portion 700 may scan the printed dots using the detecting unit 550 to detect whether the high-resolution printing has been precisely performed.

In the compensation mode, the control portion 700 may scan ink dots printed by the nozzles N1 to N10 using the detecting unit 550 and may compare the scanned ink dots with printing data to be printed to detect whether a blank dot exists. If the blank dot exists, the control portion 700 detects a defective nozzle causing the blank dot by determining a position of the blank dot. Then, the control portion 700 moves the auxiliary nozzle 560 to the blank dot and controls the auxiliary nozzle 560 to fire ink onto the blank dot and performs scanning again using the detecting unit 550 to check whether the compensation of the defective nozzle has been precisely performed.

Meanwhile, if the array type printhead 52 or the auxiliary shuttle type printhead 500 is replaced, the constant values, such as the x and y coordinates of the nozzles N1 to Nn, the gap between the auxiliary nozzles 560, the stand-by position of the detecting unit 550, Δy1, Δy2, and Δx change. Further, to increase a printing precision in the high-resolution mode and the compensation mode, the constant values may be continually updated to precisely align ink dots printed by the nozzles N1 to N10 and the auxiliary nozzles 560. The constant values may be updated just before the high-resolution mode or the defective nozzle compensation mode, or they may be automatically updated during predetermined time periods.

The control portion 700 may control the nozzles N1 to N10 to fire ink to print a nozzle test pattern, may scan the nozzle test pattern using the detecting unit 550, and may determine ink firing positions of the auxiliary nozzles 560 based on the scanned nozzle test pattern. If relative positions of the auxiliary nozzles 560 and the detecting unit 550 are not changed, and only the constant values related with the array type printhead 52 such as positions of the nozzles N1 to N10 are changed, dots printed by the nozzles N1 to N10 and the auxiliary nozzles 560 can be aligned by testing only the nozzles N1 to N10 of the array type printhead 52.

Alternatively, the control portion 700 may control the auxiliary nozzles 560 to fire the ink to the determined ink firing positions based on the scanned nozzle test pattern, may print an auxiliary nozzle test pattern, and may scan the auxiliary nozzle test pattern to correct the ink firing position of the auxiliary nozzles 560. In this case, the auxiliary nozzles 560 as well as the nozzles N1 to N10 are tested such that all constant values related to the relative positions of the nozzles N1 to N10, the auxiliary nozzles 560, and the detecting unit 550 can be updated to precisely correct the ink firing positions of the auxiliary nozzles 560. That is, the ink firing positions of the auxiliary nozzles 560 are calculated by scanning the printed nozzle test pattern using the detecting unit 550, and the calculated ink firing positions of the auxiliary nozzles 560 are corrected by printing the auxiliary nozzle test pattern using the auxiliary nozzles 560 and scanning the printed auxiliary nozzle test pattern using the detecting unit 550. In this way, the ink firing positions of the nozzles N1 to N10 and the auxiliary nozzles 560 may be precisely synchronized.

To increase the precision of the synchronization of the printed ink dots, scanning of the nozzle test pattern, printing of the auxiliary nozzle test pattern, and scanning of the auxiliary nozzle test pattern may be performed in the same swath while suspending the feeding of the printing medium (P).

To reduce the time required to synchronize the ink dots, a movement length of the auxiliary printhead 500 should be reduced. Therefore, the auxiliary printhead 500 may scan the nozzle test pattern while moving forward (or backward) in the y-axis direction, and may print the auxiliary nozzle test pattern while moving backward (or forward) in the y-axis direction. Then, the auxiliary printhead 500 may scan the printed auxiliary nozzle test pattern while moving forward (or backward) in the y-axis direction again.

Examples of the nozzle test pattern and the auxiliary nozzle test pattern will now be described according to an embodiment of the present general inventive concept. FIG. 5A is a view illustrating an example of a nozzle test pattern, according to an embodiment of the present general inventive concept, and FIG. 5B is a view illustrating an auxiliary nozzle test pattern printed in a high-density print mode with respect to the nozzle test pattern illustrated in FIG. 5A, according to an embodiment of an embodiment of the present general inventive concept. Referring to FIGS. 5A and 5B, an additional ink dot is printed between two neighboring ink dots in the y-axis direction by the auxiliary nozzle 560 to increase a print quality.

In the nozzle test pattern illustrated in FIG. 5A, dot lines D1 to D10 printed by the nozzles N1 to N10 are linearly arranged in parallel with the feeding direction of the printing media (P) (the x-axis direction). That is, the dot lines D1 to D10 of the nozzle test pattern may be parallel with the subsidiary scanning direction x (x-axis direction) and arranged separately along the main scanning direction y (y-axis direction). The y-axis distance between the nozzles N1 to N10 is R0, and thus the y-axis distance between the dot lines D1 to D10 is equal to R0. For example, when the resolution of the array type printhead 52 is 1200 dpi, R0 is 1/1200 inches.

Meanwhile, the detecting unit 550 may be an optical sensor. The optical sensor scans the printing medium (P) with light, and compares an optical output value (signal) (V) obtained from light reflected from the printing medium (P) with a threshold value (Th) to detect the nozzle test pattern and the auxiliary nozzle test pattern. To precisely detect the nozzle test pattern and the auxiliary nozzle test pattern, an optical focus of the optical sensor and the auxiliary nozzles 560 may be placed within the same swath. If a resolution of the optical sensor is less than 1/1200 inches, each dot column of the nozzle test pattern can be distinguished even when all of the nozzles N1 to N10 fire ink. Therefore, the optical output signal (V) illustrated in FIG. 5A may be obtained from the nozzle test pattern. Since an ink dot absorbs light, a level of the optical output signal (V) is lower than the threshold value (Th) along the ink dots of the dot columns. The control portion 700 receives the optical output signal (V) and determines that dots are located where the level of the optical output signal (V) is lower than the threshold value (Th). The control portion 700 sets a region interposed between two neighboring ink dots (for example, between a first dot of dot line D1 and a first dot of dot line D2) as an ink firing position of the auxiliary nozzles 560, and moves the auxiliary nozzles 560 in the y-axis direction to the ink firing position to fire the ink onto the determined ink firing position. While being moved in this way, the auxiliary nozzles 560 fire ink to form the auxiliary nozzle test pattern illustrated in FIG. 5B.

In the auxiliary nozzle test pattern illustrated in FIG. 5B, the dot lines DY1 through DY9 printed by the auxiliary nozzles 560 are interposed between the dot lines D1 through D10 printed by the nozzles N1 to N10. The y-axis distance between the each of the nozzles N1 to N10 and corresponding ones of the auxiliary nozzles 560 is R1, and thus the y-axis distance between each of the dot lines D1 to D10 and corresponding ones of the dot lines DY1 to DY9 is equal to R1. Generally, several hundreds of auxiliary nozzles 560 can be arranged along the x-axis direction. However, only four auxiliary nozzles 560 are illustrated in FIG. 4 for conciseness. Therefore, the auxiliary printhead 500 can simultaneously form four ink dots in the x-axis direction in one swath.

In the first swash S1 illustrated in FIG. 5B, the printing medium (P) stops, and the auxiliary printhead 500 moving one way in the y-axis direction forms dot lines DY1 through DY9. Then, the auxiliary printhead 500 moves the opposite way in the y-axis direction to check whether the dot lines DY1 through DY9 are formed at desired positions using the optical sensor. If the dot lines DY1 through DY9 are formed at the desired positions, the optical output signal (V) can be obtained. If the dot lines DY1 through DY9 are not formed at the desired positions, the ink firing positions of the auxiliary nozzles 560 are corrected by the control portion 700. The control portion 700 repeats the correction of the ink firing positions of the auxiliary nozzles 560 for the second swath S2 and the third swath S3 until a desired optical output signal (V) is obtained. If the optical output signal (V) of the auxiliary nozzle test pattern is the desired optical output signal (V), the control portion 700 stops the alignment operation and prints image data using the nozzles N1 to N10 and the auxiliary nozzles 560 in a high-resolution mode.

FIG. 6A is a view illustrating a nozzle test pattern when defective nozzles exist, according to an embodiment of the present general inventive concept, and FIG. 6B is a view illustrating an auxiliary nozzle test pattern printed in a compensation mode with respect to the nozzle test pattern illustrated in FIG. 6A, according to an embodiment of an embodiment of the present general inventive concept. When the third, fourth, and eighth nozzles N3, N4, and N8 are defective, columns of missing dots (not-printed dots) DM3, DM4, and DM8 appear in the nozzle test pattern illustrated in FIG. 6A. In the compensation mode, the detecting unit 550 scans the nozzle test pattern and detects the missing dot lines DM3, DM4, and DM8 as the detecting unit 550 moves in the y-axis direction, such that the defective nozzles N3, N4, and N8 can be detected. When the detecting unit 550 scans the nozzle test pattern having the columns of missing dots DM3, DM4, and DM8, the detecting unit 550 generates an optical output signal (V), as illustrated in FIG. 6A.

Next, the auxiliary nozzles 560 moves to form additional dot lines DD3, DD4, and DD8, such that the auxiliary nozzle test pattern illustrated in FIG. 6B can be printed. Then, the optical sensor (the detecting unit 550) scans the auxiliary nozzle test pattern to check whether the dot lines DD3, DD4, and DD8 are precisely formed as the optical sensor (the detecting unit 550) moves in the y-axis direction. When the optical sensor (the detecting unit 550) determines that the dot lines DD3, DD4, and DD8 are precisely formed, a desired optical output signal (V) can be obtained, as illustrated in FIG. 6B. The control portion 700 repeats the compensation for each swath until the suitable optical output signal (V) of the optical sensor is obtained for each swath. If the optical output signal (V) obtained from the auxiliary nozzle test pattern is determined to be suitable, the control portion 700 terminates the compensation operation. The control portion 700 prints the image data using the nozzles N1, N2, N5-N7, N9, and N10 while compensating for the defective nozzles N3, N4, and N8 using the auxiliary nozzles 560, such that the compensated image can be printing without missing dots.

FIG. 7A is a view illustrating a nozzle test pattern when defective nozzles exist, according to an embodiment of the present general inventive concept, and FIG. 7B is a view illustrating an auxiliary nozzle test pattern printed in high-density print and compensation modes with respect to the nozzle test pattern illustrated in FIG. 7A, according to an embodiment of an embodiment of the present general inventive concept. In FIGS. 7A and 7B, the control portion 700 performs the high-density print mode and the compensation mode simultaneously. The operation of the control portion 700 has been separately described above for the high-density print mode and the compensation mode. Thus, a further description thereof will be omitted.

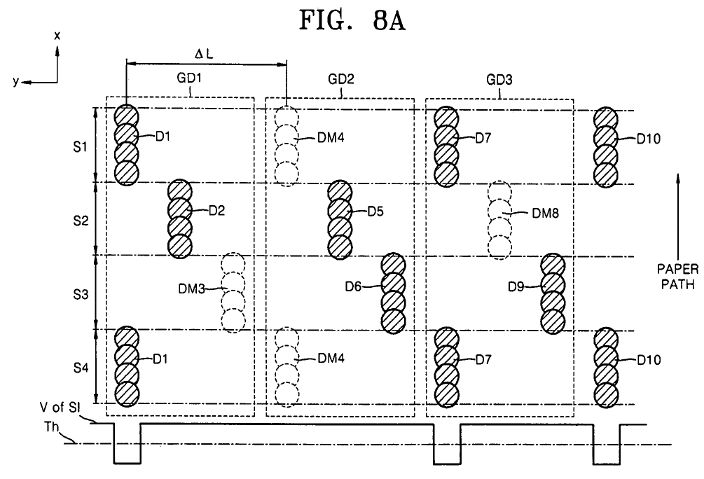

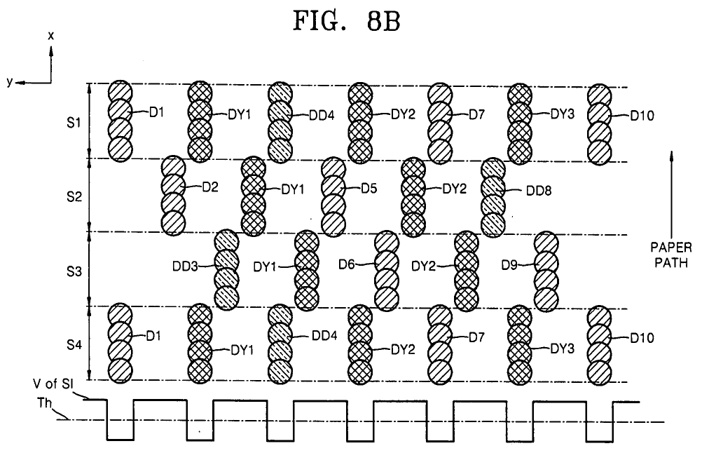

FIG. 8A is a view illustrating a nozzle test pattern printed using grouped nozzles, according to an embodiment of the present general inventive concept, and FIG. 8B is a view illustrating an auxiliary nozzle test pattern printed in high-density print and compensation modes with respect to the nozzle test pattern illustrated in FIG. 8A, according to an embodiment of an embodiment of the present general inventive concept. When a resolution of the array type printhead 52 is 1200 dpi, a resolution of the optical sensor (detecting unit 550) is less than 1/1200 inches. However, when the resolution of the optical sensor is larger than 1/1200 inches, the nozzle test pattern and the auxiliary nozzle test pattern illustrated in FIGS. 5A through 7B cannot be used since the y-axis distance R0 between the dot lines D1 through D10 printed by the nozzles N1 through N10 is smaller than the resolution of the optical sensor. That is, the optical sensor cannot distinguish the respective dot lines D1 through D10 of the patterns illustrated in FIGS. 5A through 7B.

Therefore, in this case, the nozzles N1 to N10 may be divided into a plurality of groups (such as groups GN1, GN2, and GN3 illustrated in FIG. 4 or groups GD1, GD2, and GD3 illustrated in FIG. 8A), and ink may be fired from some of the nozzles of the respective groups to form a nozzle test pattern, as illustrated in FIG. 8A and 8B. In the nozzle test pattern illustrated in FIG. 8A, a y-axis distance between dot lines may be larger than a resolution of the optical sensor. For example, referring to FIG. 4, the nozzles N1 to N1 0 are divided into nozzle groups each having three nozzles. Three nozzle groups GN1, GN2, and GN3 are illustrated in FIG. 4, and three nozzle groups GD1, GD2, and GD3 are illustrated in FIG. 8A, for the nozzles N1 through N9 corresponding to dot lines D1 through D9. A y-axis distance, between the nozzle groups is ΔL. If the resolution of the array type printhead 52 is 1200 dpi, the ΔL is 3/1200 inches. Here, the resolution of the optical sensor may be larger than 1/1200 inches but smaller than 3/1200 inches. If the resolution of the optical sensor increases, one nozzle group may include more than the three nozzles illustrated in FIGS. 4 and 8A.

Meanwhile, referring to FIG. 4, four auxiliary nozzles 560 may be arranged for one swath. Therefore, in FIG. 8B, four dots are simultaneously printed in the x-axis direction. In the nozzle test pattern illustrated in FIG. 8A, the y-axis distance between the dots is ΔL. To test all of the nozzles N1 through Nn of the array type printhead 52 that are divided into groups GN1, GN2, and GN3 (see FIG. 4) or groups GD1, GD2, and GD3 (see FIG. 8A), each having three nozzles, dots must be formed on at least three swaths. In a first swath S1, the control portion 700 identifies locations of the nozzles N1, N7, and N10 using positions of dot lines D1, D7, and D10 and identifies a defective nozzle using a missing dot column DM4 based on an optical output signal (V) of the first swath S1 of the optical sensor illustrated in FIG. 8A. Then, the control portion 700 controls the auxiliary nozzles 560 to print dot lines DY1, DD4, DY2, and DY3 and checks whether the dot lines DY1, DD4, DY2, and DY3 are precisely printed. In this way, the control portion 700 also processes second swath S2 and third swath S3. The control portion 700 repeats this operation until a suitable optical output signal (V) is obtained from each of the three swaths S1, S2, and S3, as illustrated in FIG. 8B. If the optical output signal (V) obtained from each swath of the auxiliary nozzle test pattern is determined to be suitable, the control portion 700 controls the array type printhead 52 and the auxiliary shuttle type printhead 500 to print the desired image data in the high-resolution and compensation modes.

According to embodiments of the present general inventive concept, a method of controlling an inkjet image forming apparatus includes selecting at least one of a high-resolution print mode and a compensation mode, determining an ink firing position between ink dots printed by two neighboring nozzles in a main scanning direction and firing additional ink onto the determined ink firing position using auxiliary nozzles when the high-resolution mode is selected, and detecting an ink firing position where a missing dot exists due to a defective nozzle and firing additional ink onto the ink firing position using the auxiliary nozzles when the compensation mode is selected.

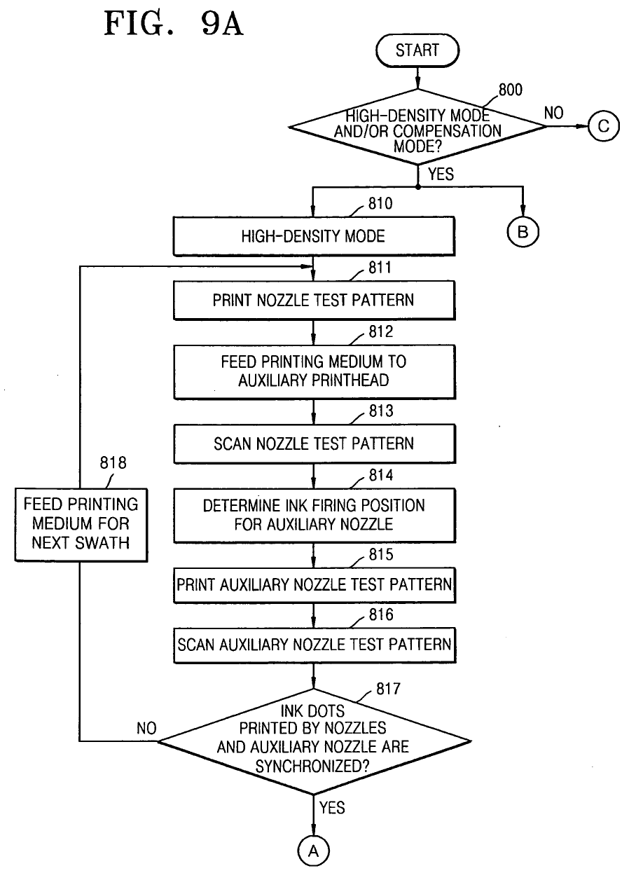

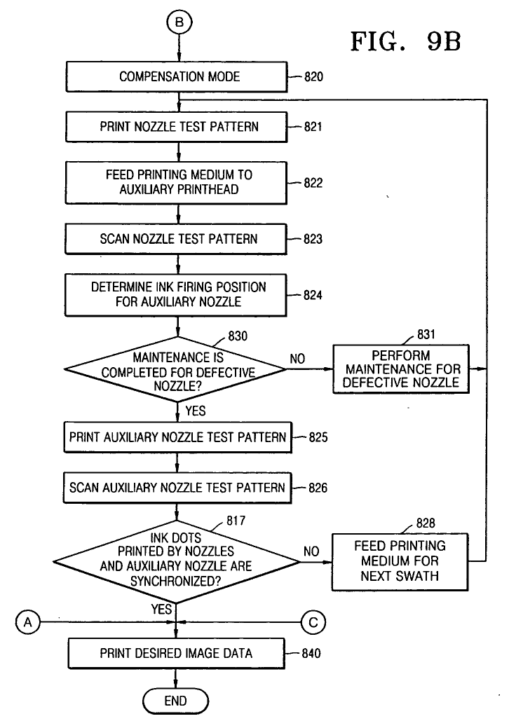

FIGS. 9A and 9B are flowcharts illustrating a method of controlling an inkjet image forming apparatus, according to an embodiment of the present general inventive concept. In operation 800 of FIG. 9A, one of a high-resolution mode and a compensation mode is selected, or both of the high-resolution and compensation modes are selected. Referring to FIGS. 1, 9A, and 9B, if neither of the high-resolution mode and the compensation mode is selected in operation 800, image data are printed by firing ink using nozzles of an array type printhead 52 while an auxiliary nozzle(s) 560 of an auxiliary shuttle type printhead 500 remains idle in operation 840.

When the high-resolution mode is selected (operation 810), the nozzles of the array type printhead 52 fire ink to print a nozzle test pattern on a printing medium (P) in operation 811, and the printing medium (P) is fed to the auxiliary shuttle type printhead 500 in operation 812. In operation 813, a detecting unit 550 scans the nozzle test pattern printed on the printing medium (P). In operation 814, a control portion 700 determines an ink firing position between ink dots of the nozzle test pattern printed by two neighboring nozzles using the scanned result for the auxiliary nozzle(s) 560. In operation 815, the auxiliary nozzle(s) 560 fires ink onto the ink firing position determined by the control portion 700 to print an auxiliary nozzle test pattern. In operation 816, the detecting unit 550 scans the auxiliary nozzle test pattern. In operation 817, it is determined whether the ink dots printed by the nozzles and the auxiliary nozzle(s) 560 are synchronized using the scanned result. If it is determined that the ink dots printed by the nozzles and the auxiliary nozzle(s) 560 are synchronized, desired image data are printed using the nozzles and the auxiliary nozzle(s) 560 in the high-density mode (operation 840). On the other hand, if it is determined that the ink dots printed by the nozzles and the auxiliary nozzle(s) 560 are not synchronized, the printing medium (P) is further fed for a next swath in operation 818, and operations 811 through 817 are repeated until it is determined that the ink dots printed by the nozzles and the auxiliary nozzle(s) 560 are synchronized.

Meanwhile, when the compensation mode is selected (operation 820), the nozzles of the array type printhead 52 fire ink to print a nozzle test pattern on the printing medium (P) in operation 821. In operation 822, the printing medium (P) is fed to the auxiliary printhead 500. In operation 823, the detecting unit 550 scans the nozzle test pattern printed on the printing medium (P). In operation 824, the control portion 700 identifies a missing dot using the scanned result, and determines a position of the missing dot as a position of a defective nozzle and an ink firing position of the auxiliary nozzle(s) 560. Here, a maintenance portion 80 (see FIG. 1) may operate to repair the defective nozzle. However, in some cases, the defective nozzle may not be repaired even though the maintenance portion 80 operates continuously.

Therefore, the control portion 700 determines whether the maintenance portion 80 is required to be further operated or has been sufficiently operated (operation 830). If it is determined that the maintenance portion 80 is required to be further operated, the maintenance portion 80 performs wiping and spitting operations on the defective nozzle in operation 831, and operations 821 through 824 are repeated. On the other hand, if it is determined that the maintenance portion 80 has been sufficiently operated, the auxiliary nozzle(s) 560 fires ink onto the ink firing position determined in operation 824 to form an auxiliary nozzle test pattern (operation 825). In operation 826, the detecting unit 550 scans the auxiliary nozzle test pattern. In operation 827, it is determine whether dots of the auxiliary nozzle test pattern printed by the nozzles and the auxiliary nozzle(s) 560 are synchronized using the scanned result. If it is determined that the dots of the auxiliary nozzle test pattern printed by the nozzles and the auxiliary nozzle(s) 560 are synchronized, desired image data are printed by firing ink using the nozzles and the auxiliary nozzle(s) 560 in the compensation mode (operation 840). On the other hand, if it is determined that the dots of the auxiliary nozzle test pattern printed by the nozzles and the auxiliary nozzle(s) 560 are not synchronized, the printing medium (P) is fed for a next swath in operation 828 and operations 811 through 817 are repeated until it is determined that the dots of the auxiliary nozzle test pattern printed by the nozzles and the auxiliary nozzle(s) 560 are synchronized.

If the high-resolution mode and the compensation mode are selected together in operation 800, operations 811 through 817 are performed simultaneously with operations 821 through 827. In this case, the auxiliary nozzle(s) 560 fires ink onto a position between dots printed by two neighboring nozzles and onto a missing dot caused by a defective nozzle. If the dots printed by the nozzles and the auxiliary nozzle(s) 560 are synchronized, desired image data are printed by firing ink using the nozzles and the auxiliary nozzle(s) 560 in the high-density and compensation modes (operation 840). On the other hand, if the alignment of the dots printed by the nozzles and the auxiliary nozzle(s) 560 are not synchronized, the printing medium (P) is further fed for the next swath (operations 818 and 828), and operations 811 through 817 or operations 821 through 827 are repeated until the dots becomes synchronized.

An inkjet image forming apparatus and a control method of the inkjet image forming apparatus according to embodiments of the present general inventive concept, an auxiliary printhead having an auxiliary nozzle and a detecting unit is reciprocated in a main scanning direction to increase print quality in a high-density mode, and to precisely compensate for defective nozzles in a compensation mode, so that nozzle density restrictions and difficulties in compensating for defective nozzles can be overcome.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A printhead unit of an image forming apparatus, the printhead unit comprising:
a first printhead comprising a plurality of first nozzles to eject ink onto a printing medium to form an image on the printing medium; and
a second printhead spaced apart from the first printhead by a predetermined distance in a conveying direction of the printing medium and moveable in a main scanning direction perpendicular to the conveying direction, the second printhead comprising a plurality of second nozzles to eject ink onto the printing medium to increase a print resolution of the printhead unit and/or to compensate for a defective nozzle of the plurality of first nozzles.

2. The printhead unit of claim 1, wherein the first printhead is an array type printhead and the second printhead is a shuttle type printhead.

3. The printhead unit of claim 1, further comprising:
a detecting unit attached to the second printhead to detect the image printed on the printing medium; and
a control unit to control operations of the first printhead, the second printhead, and the detecting unit.

4. The printhead unit of claim 3, wherein the detecting unit and the plurality of second nozzles are spaced apart from each other by a first predetermined distance in the main scanning direction.

5. The printhead unit of claim 4, wherein the detecting unit and the plurality of first nozzles are spaced apart from each other by a second predetermined distance in the conveying direction, and the detecting unit is spaced apart from a nozzle of the plurality of first nozzles by a third predetermined distance in the main scanning direction.

6. The printhead unit of claim 5, wherein the control unit stores constant values corresponding to the first, second, and third predetermined distances.

7. The printhead unit of claim 6, wherein the control unit synchronizes the ejection of the ink by the plurality of first nozzles and the plurality of second nozzles using the constant values.

8. The printhead unit of claim 6, wherein the control unit continuously updates the constant values to precisely align ink dots ejected by the first and second printheads onto the printing medium.

9. The printhead unit of claim 6, wherein the control unit updates the constant values during predetermined time periods to precisely align ink dots ejected by the first and second printheads onto the printing medium.

10. The printhead unit of claim 1, wherein the first printhead ejects a plurality of ink drops at locations on the printing medium corresponding to the plurality of first nozzles, and the second printhead ejects at least one auxiliary ink drop between two adjacent ink drops of the plurality of ink drops to increase the print resolution of the printhead unit.

11. The printhead unit of claim 1, wherein the plurality of first nozzles includes the defective nozzle, and the second printhead ejects at least one ink drop at a location on the printing medium corresponding to the defective nozzle to compensate for the defective nozzle.

12. An inkjet image forming method, comprising:
ejecting ink dots onto a printing medium using a plurality of first nozzles of a first printhead as the printing medium moves in a conveying direction to form a first print line of an image;
stopping the movement of the printing medium and ejecting auxiliary ink dots onto predetermined positions on the first print line using a plurality of second nozzles of a second printhead spaced apart from the first printhead by a predetermined distance in the conveying direction, the second printhead being moveable in a main scanning direction perpendicular to the conveying direction; and
moving the printing medium having the ejected ink dots and auxiliary ink dots in the conveying direction and repeating the ejecting of the ink dots using the plurality of first nozzles, the stopping of the movement of the printing medium, and the ejecting of the auxiliary ink dots using the plurality of second nozzles for each print line of the image.

13. The method of claim 12, wherein the predetermined positions on the first print line correspond to at least one of locations between adjacent one of the ink dots ejected by the plurality of first nozzles, and locations of blank dots of at least one defective nozzle of the plurality of first nozzles.

14. The method of claim 12, wherein the predetermined positions on the first print line correspond to locations between adjacent one of the ink dots ejected by the plurality of first nozzles, and locations of blank dots of at least one defective nozzle of the plurality of first nozzles.

15. An image forming apparatus, comprising:
a first printhead having a plurality of first nozzles to form an image on a printing medium;
a second printhead having a plurality of second nozzles; and
a control unit to control the second printhead to form a second image on the printing medium with the image according to one of a high definition mode and a compensation mode.
